(19) United States
(12) Patent Application Publication
(10) Pub. No.: US 2014/0360718 A1
(43) Pub. Date: Dec. 11, 2014

(54) SAND FILTER AND METHOD OF MANUFACTURE

(71) Applicant: ANTON ENERGY SERVICES CORPORATION, Calgary (CA)

(72) Inventors: Jian (James) MA, Beijing (CN); Yonghua ZHANG, Beijing (CN)

(73) Assignee: ANTON ENERGY SERVICES CORPORATION, Calgary (CA)

(21) Appl. No.: 14/294,771

(22) Filed: Jun. 3, 2014

Related U.S. Application Data
(60) Provisional application No. 61/833,313, filed on Jun. 10, 2013.

(51) Int. Cl. E21B 43/08; B23K 31/02

(52) U.S. Cl. CPC E21B 43/086; B23K 31/02
USPC 166/231; 166/234; 228/145; 228/101

(57) ABSTRACT

Cylindrical screens and screen assemblies for use with perforated base pipe or casing for sand control in wellbores have generally longitudinally extending slots punched in the screen. The outer surface of the screen material is deformed below the inner surface causing apertures to form along the longitudinal edges of the slot. The slots are generally longitudinally aligned with the longitudinal axis of the cylindrical screens whether butt-welded or spiral-rolled and welded by determining the angle at which the slots need to be punched to result in such alignment. End caps which connect between the screen and the casing extend over the ends of the cylindrical screen and are welded thereto to minimize sand entry. At least one of the end caps may include an expansion joint to permit relative expansion and contraction between the screen and the casing particularly when used in thermal recovery operations.

### CROSS-REFERENCE TO RELATED APPLICATIONS

This application claims the benefit of U.S. Provisional Patent application Ser. No. 61/833,313, filed Jun. 10, 2013, the entirety of which is incorporated herein by reference.

### FIELD OF THE INVENTION

Embodiments herein relate to screens for filtering sand in downhole applications and, more particularly, to improved sand screens and methods of manufacture and assembly

### BACKGROUND

Sand production often occurs during the development of oil and gas fields due to various geological or mining factors. During drilling and production in oil and gas reservoirs, particularly heavy oil recovery in unconsolidated sandstone, sand production becomes a more serious issue when the particular oilfield enters into a high water-cut stage. Prevention of sand production becomes a primary problem that must be dealt with in the development of oil and gas fields.

Produced sand results in serious and significant erosion of downhole equipment. Further, it can lead to sand accumulation in manifolds and fuel tanks at surface. Under extreme sand production, voids can be formed outside the wellbore casing, leading to collapse of the formation stratum which may result in abandonment of the well and the costly losses associated therewith.

Prevention of sand production, using mechanical means, such as sieve pipes or screens associated with wellbore casing, is an effective way to resolve the issue of sand production in oil and gas wells. Screens can directly reduce costs associated with sand production and improve the success rate of sand prevention. Use of screens in association with simple site operations generally offer long term effective sand prevention control. Such methods are especially effective in respect to sand prevention in the production from horizontal wells.

The exploitation of unconventional reservoirs is currently receiving more and more attention, especially the development and utilization of heavy oil reservoirs. Due to the special nature of such reservoirs, being relatively shallow, and poor mobility of crude oil therein, a long-distance horizontal well is usually adopted for well completion. The length of the horizontal segment is often about 800 to about 1000 m. In the running-in process, due to great friction resistance and poor mobility of the heavy oil, it is generally necessary to utilize thermal recovery technology. In the development of such reservoirs, high durability requirements are imposed for screens, which includes corrosion resistance, high strength, high mobility and low cost, in addition to the ability to achieve long-term effective sand prevention. Conventionally, mechanical sand prevention applied to the casing string includes slotted screens, wire-wrapped screen, metal cotton sand screen, metal mesh screen, punched, slotted screen, and pre-packed screens.

Conventional manufacture of slotted screens typically utilizes metal cutting machinery or laser methods, to cut slots in casing in accordance with API standards to form various slotted patterns that function as sand filters. Such cutting technologies have low efficiency and the quality of screens cannot be fully guaranteed. Typically, the seepage or open area of the screen is small, such as maximized at 2%-3% of the whole. Further, after slotting, the strength of the casing body declines significantly, and is prone to deformation when running downhole into completed wells, as the casing is unable to bear large external loads.

In the case of thermal recovery of heavy oil using steam, such as Steam Assisted Gravity Drainage (SAGD), formation erosion is significant creating large amounts of flowing sand which results in enlarging of the apertures in the screen and ultimately, failure of the screen resulting in significant production of sand.

Under thermal conditions, such as during SAGD where temperatures may exceed 200° C., screens, screen components and underlying base pipes or casing which are made of different materials can undergo different thermal expansion and contraction. As a result, connections between the components of the screened casing can be damaged, such as by buckling of the screen, resulting in failures of the screen and loss of sand control.

Conventional wire-wrapped screens are formed using stainless steel wire which is wrapped about the casing, conforming to API standards. The process of preparing wire-wrapped screens is quite costly. The winding direction of the wire is typically vertical to the running-in direction and thus, wire wrapped screens are very easily deformed when running-in, particularly through the heel portion of a horizontal well and the long-distance horizontal segment thereafter toward the toe of the well. When under stress in non-linear portions of the wellbore, such as at the heel of a horizontal well or where the wellbore is irregular, damage of the wrapped screens may occur. Typically such damage occurs as a result of catching and pulling out of wires and deformation of the wire-wrap about the casing. Further, wire-wrapped screens are not typically used alone. In most cases, gravel is used to fill at least the space between the wrapped wire screen and base casing, which complicates assembly and use of such screens. Those of skill in the art will appreciate that upon failure of the screen, the screens should not be pulled out of the well as there is a risk of damage to the well itself.

Advanced screen technologies such as metal cotton sand screens, metal mesh screens and pre-packed screens, have not been widely promoted and used in oil-fields due to the complex processing technology, high cost and limited applicability.

Conventional punched screens are typically manufactured from a flat sheet of material, such as stainless steel in which the material is punched inwardly to form depressions having apertures associated therewith for fluid passage and sand exclusion. The material is thereafter folded into a cylinder and butt-welded along a linear seam. As one of skill will appreciate such construction results in a screen having relatively poor strength. The punched apertures formed in the stainless steel are typically at an angle to the axis of the cylinder and a base casing which underlies the screen. Angled from the longitudinal axis, the punches present edges which may be susceptible to being caught by protrusions in the wellbore, particularly during running-in. Thus, the apertures may be caused to open, resulting in increased amounts of sand passing therethrough, eventually leading to screen failure.

Clearly there is a need for robust screens capable of resisting damage during run-in, and capable of maintaining screen integrity for preventing sand production and the problems associated therewith.

### SUMMARY

Embodiments of a screen assembled over a base pipe or casing, the screen, a screen assembly with endcaps for assembling over the casing and methods for manufacture and assembly of same utilize slots which are precision punched in screen material for forming apertures in the screen to control sand production. In embodiments, the slots are punched at an angle relative to a longitudinal axis of a strip of screen material such that when rolled and welded, the slots are generally longitudinally aligned with a longitudinal axis of the cylindrical screen formed thereby. The strip may be spiral rolled and spiral welded, the angle of the slots being determined prior to punching so as to result in the generally longitudinally extending slots. The endcaps extend over the ends of the screen and are affixed thereto so as to minimize entry of sand. In embodiments, at least one of the end caps further incorporates an expansion joint so as to accommodate thermal expansion and contraction between the screen and the casing.

In one broad aspect a screen assembly for use with a perforated casing having a longitudinal axis, for control of sand production therethrough in a wellbore, comprises a cylindrical screen for fitting concentrically about the casing. The cylindrical screen is formed from a strip of material having a longitudinal extent, the strip being rolled in a spiral and affixed along the longitudinal extent in a spiral seam. The cylindrical screen has a longitudinal axis common with the axis of the casing, an outer surface and an inner surface. A plurality of slots are punched in the screen, each slot having leading and trailing ends and first and second sides aligned with the common axis. The punched material is deformed inwardly for forming each slot so as to space the outer surface within the slot a distance below the inner surface of the material thereabout. The inward deformation forms an aperture along each of the first and second sides of the slot and a smooth transition at the leading and trailing ends. The apertures are fluidly connecting from outside the screen to the screen's bore while excluding at least a portion of sand from passing therethrough. First and second tubular end caps are positioned at opposing ends of the screen for connecting between the screen and the casing and retaining the screen thereabout.

In embodiments, the slots can be angled relative to the common axis from about 0° to about 90° and more particularly less than about 45° and even more particularly the slots are from about 0° to about 15° and are generally longitudinally extending.

In another broad aspect, a screen for use with a perforated casing having a longitudinal axis, for control of sand production therethrough in a wellbore comprises a cylindrical screen for fitting concentrically about the casing. The cylindrical screen is formed from a strip of material having a longitudinal extent, the strip rolled in a spiral and affixed along the longitudinal extent in a spiral seam. The screen has a longitudinal axis common with the longitudinal axis of the casing, an outer surface and an inner surface. A plurality of slots are punched in the screen, each slot having leading and trailing ends and first and second sides aligned with the common axis. The punched material is deformed inwardly for forming each slot so as to space the outer surface within the slot a distance below the inner surface of the material thereabout forming an aperture along each of the first and second sides of the slot and a smooth transition at the leading and trailing ends. The apertures are fluidly connecting from outside the screen to the screen's bore while excluding at least a portion of sand from passing therethrough.

In embodiments, the punched slots are rectangular, trapezoidal or semi-elliptical. The apertures have a width from about 0.15 mm to about 0.3 mm.

In yet another broad aspect, a screen assembly for use with a perforated casing having a longitudinal axis, for control of sand production therethrough, comprises a cylindrical screen for fitting concentrically about the casing, the screen having a longitudinal axis common therewith, an outer surface and an inner surface. A plurality of slots are punched in the screen. Each slot has leading and trailing ends and first and second sides aligned with the common axis, the punched material being deformed inwardly for forming each slot so as to space the outer surface within the slot a distance below the inner surface of the material thereabout forming an aperture along each of the first and second sides of the slot and a smooth transition at the leading and trailing ends. The apertures are fluidly connecting from outside the screen to the screen's bore while excluding at least a portion of sand from passing therethrough. First and second tubular end caps are positioned at opposing ends of the screen for connecting between the screen and the casing and retaining the screen thereabout. Each end cap has a cap bore formed therethrough, the cap bore having a first portion having a first inner diameter to engage concentrically over the casing for affixing the end cap thereto and a second portion extending from the first portion and having a second inner diameter for engaging concentrically over the casing and the screen.

In yet another broad aspect, a method for manufacturing a cylindrical screen for use with a perforated casing having a longitudinal axis, for control of sand production therethrough in a wellbore comprises determining a longitudinal axis of a strip of material used for forming the screen. An angle is determined relative to the longitudinal axis at which a plurality of slots are to be punched so that when the strip of material is rolled in a spiral for forming a cylinder, the plurality of slots are generally longitudinally aligned with the longitudinal axis. The plurality of slots are punched at the determined angle in the strip of material wherein each slot has a leading and a trailing end and first and second sides, the punched material being deformed inwardly for forming each slot so as to space the outer surface within the slot a distance below the inner surface of the material thereabout forming an aperture along each of the first and second sides of the slot and a smooth transition at the leading and trailing ends. The apertures are fluidly connecting from outside the screen to the screen's bore while excluding at least a portion of sand from passing therethrough. The strip of material is spiral rolled for forming the cylinder; and thereafter a spiral seam is welded at abutting longitudinal edges of the strip of material for forming the cylindrical screen.

In yet another broad method aspect, a method for installation of a screen assembly, for use with perforated casing having a longitudinal axis, for control of sand production therethrough in a wellbore, comprises manufacturing the cylindrical screen and sliding an end cap over each opposing end of the screen. Each end cap has a first portion having a first inner diameter to engage concentrically over the casing for connection thereto; and a second portion extending from the first portion and having a second inner diameter for engaging concentrically over the casing and the screen. Each end cap is welded to the screen at an end adjacent the second portion of the bore.

### BRIEF DESCRIPTION OF THE DRAWINGS

FIG. 1 is a sectional view of sand screens, according to embodiments taught herein, in use in a wellbore;

FIGS. 2A to 2C are perspective views of a portion of a screen according to FIG. 1, illustrating slots punched in screen material for forming apertures therein, more particularly

FIG. 2A illustrates trapezoidal slots punched in the screen material;

FIG. 2B illustrates semi-elliptical slots punched in the screen material; and

FIG. 2C illustrates generally rectangular slots punched in the screen material;

FIG. 3A is a partial perspective view of an embodiment of a screen being formed from a flat strip of screen material, the material being rolled about a longitudinal axis of the material;

FIG. 3B is a partially sectioned side view of the screen formed according to FIG. 3A, longitudinal edges of the screen material being welded in a butt-weld for forming a cylindrical screen having a longitudinal weld;

FIG. 4A is a partial perspective view of an embodiment of a screen being formed from a flat strip of screen material, the material being rolled in a spiral;

FIG. 4B is a partially sectioned side view of the screen formed according to FIG. 4A, longitudinal edges of the screen material being spiral-welded for forming a cylindrical screen having a spiral weld;

FIG. 5 is a plan view of screen material punched for forming the screen of FIGS. 4A and 4B, the slots being angled relative to the longitudinal axis of the screen material;

FIGS. 6A to 6C are plan views of screen material punched according to FIG. 5, each screen material having a different density of slots and apertures therein for forming screens having different percentages of open area therein;

FIG. 7 is a perspective view representative of apparatus for punching slots in strips of screen material;

FIG. 8 is a perspective view representative of apparatus for spiral-rolling punched screen material, spiral-welding the longitudinal edges of the material for forming cylindrical screens and for cutting the cylindrical screens into desired lengths;

FIG. 9 is a side view of a casing having two, spaced apart cylindrical screens formed according to FIGS. 4A and 4B installed thereon over perforated areas of the casing;

FIG. 10A is a section view of one of the screens, according to FIG. 9, installed over the casing using opposing end caps;

FIG. 10B is a cross-sectional view of an end cap of FIG. 10A;

FIG. 11 is a section view according to FIG. 10, the casing having been removed for clarity;

FIG. 12 is a cross-sectional view of a screen assembly according to an embodiment wherein the assembly has an expansion joint associated with an end cap to permit relative thermal expansion between the screen and the casing, the moveable ring overlaying an end of the cylindrical screen and having seals between a moveable ring and a connecting ring of the expansion joint;

FIG. 13 is a cross-sectional view of an embodiment of the screen assembly of FIG. 12 without the seals between the moveable ring and the connecting ring of the expansion joint;

FIG. 14 is a cross-sectional view of an embodiment of the screen assembly of FIG. 12, the moveable ring underlying an end of the cylindrical screen; and

FIG. 15 is a cross-sectional view of an embodiment of the screen assembly of FIG. 14 without the seals between the moveable ring and the connecting ring of the expansion joint.

### DETAILED DESCRIPTION OF THE PREFERRED EMBODIMENTS

Embodiments of a slot-punched, cylindrical screen 10 taught herein, manufactured according to methods also described, are relatively simple, robust and have reduced susceptibility to being damaged during run-in to the wellbore.

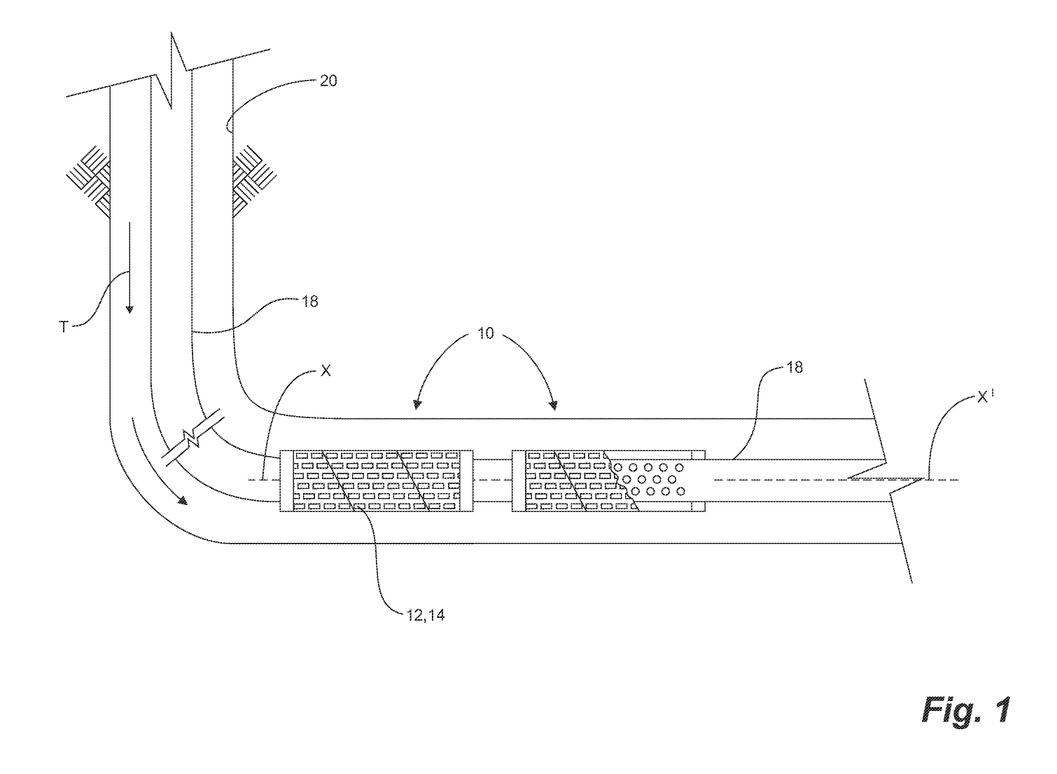

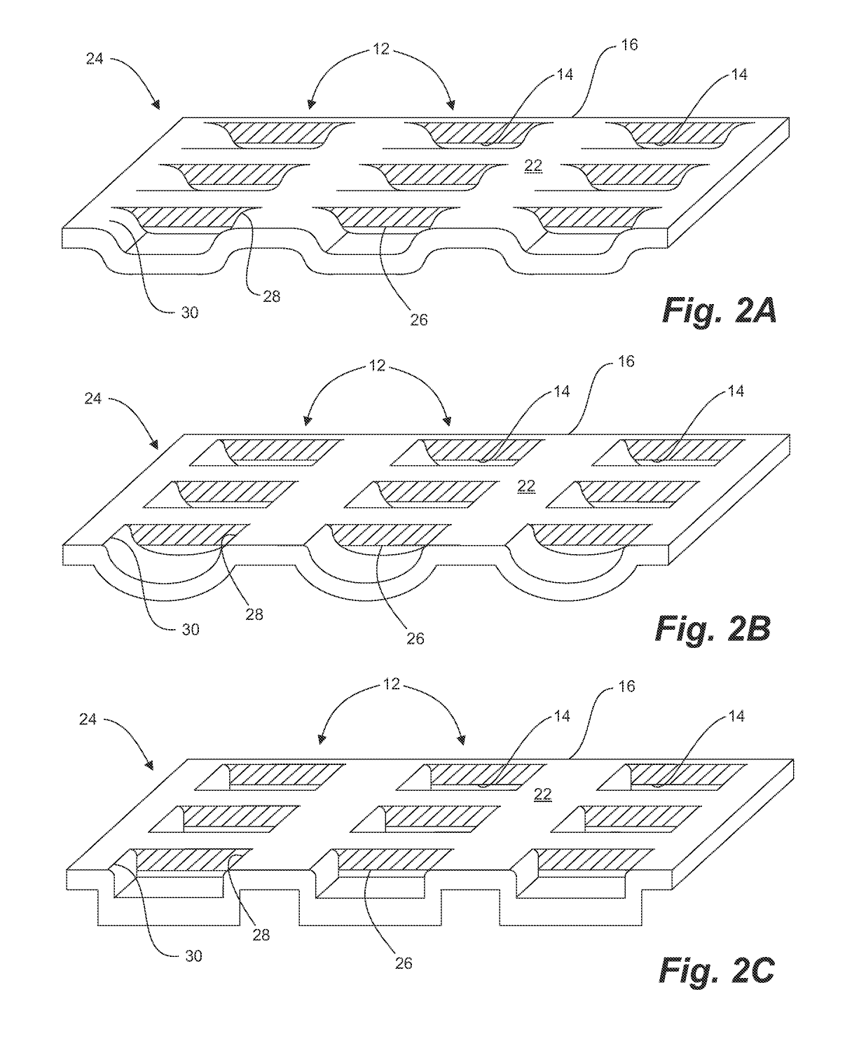

Having reference to FIGS. 1 and 2, a plurality of slots 12 with apertures 14 are punched in screen material 16, so as to have the slots 12 and apertures 14 generally parallel to a longitudinal axis X of the cylindrical screen 10, when formed. Further, the slots 12 and apertures are also generally parallel to a longitudinal axis X′ of a perforated base pipe, liner or casing 18, referred to herein as casing 18, over which the screen 10 is positioned. The slots 12 and apertures 14 are thus generally aligned with a direction of travel T of the casing 18 when run-in to a wellbore 20, incorporated in a string of casing 18.

As shown in FIGS. 2A-2C, each slot 12 is precision punched for forming the apertures 14 in the screen material 16, typically stainless steel. An outer surface 22 of a flat sheet or strip 24 of material 16 is punched inward for forming the slot 12 such that the outer surface 22 of the punched material 16 is spaced below an inner surface 26 of the remaining material 16, the slot 12 extending between a leading 28 and trailing end 30 of the slot 12. The apertures 14 form as a result of the punching beyond a thickness of the material and extend along opposing longitudinal edges 32,34 of the slot 12. The leading and trailing ends 28,30 transition smoothly from the outer surface 22 into the slot 12 and thus, do not present edges which can be easily caught during run-in. Further, the apertures 14 are formed towards the inner surface 26 of the screen 10 which further protects the apertures 14 from damage from without.

The apertures 14 permit passage of fluids therethrough while excluding the passage of sand greater in size than a size of the aperture 14. The size of the apertures 14 can be varied depending upon the type and size of sand to be excluded, which may be particular to the formation in which the screen 10 is to be used.

In embodiments, the apertures 14 are precision punched in the screen material for forming apertures which vary in width from about 0.15 mm to about 0.3 mm. A plurality of screens 10 may be pre-manufactured having aperture widths which vary in increments of 30-50 microns so as to provide a variety of filtering grades suitable for use in the oil and gas industry.

In embodiments, following punching a plurality of slots 12 in the flat sheet 24 of stainless steel, the sheet 24 is rolled for forming the cylindrical screen 10.

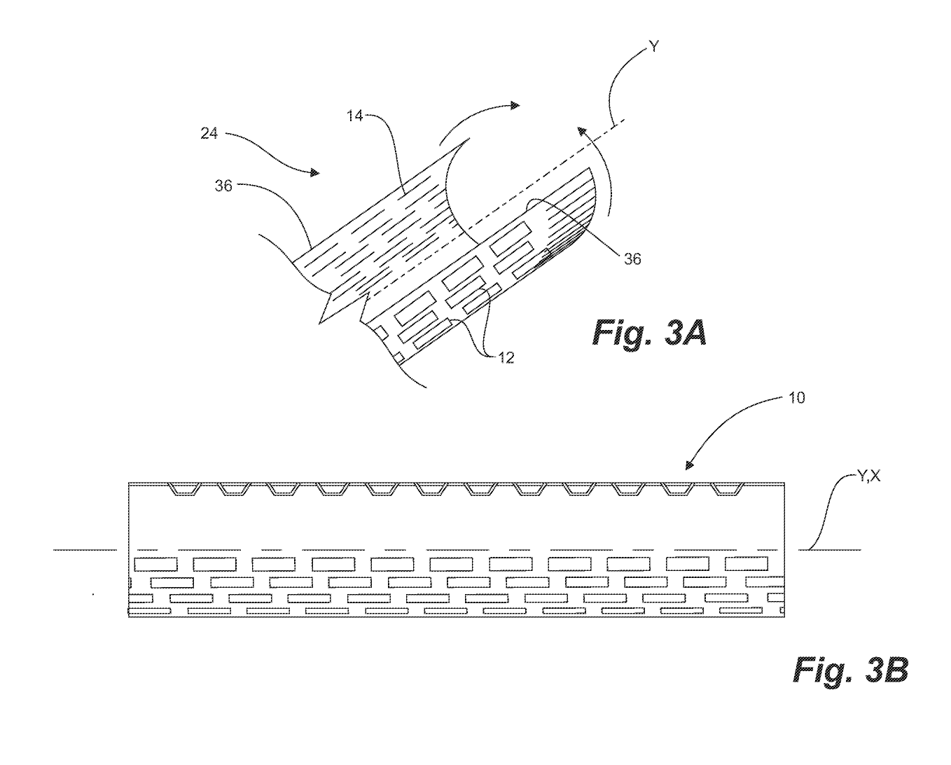

Having reference to FIGS. 3A and 3B, in an embodiment, the slots 12 are punched parallel to a longitudinal axis Y of the flat sheet or strip 24 of stainless steel. The strip 24 is rolled about the axis Y (FIG. 3A) for forming the cylindrical screen 10 (FIG. 3B) and longitudinal edges 36 are welded in a straight weld pass, resulting in a butt-weld. Thus, the slots 12 in the cylindrical screen 10, when formed, are longitudinally extending and generally parallel to the longitudinal axis X of the cylindrical screen 10.

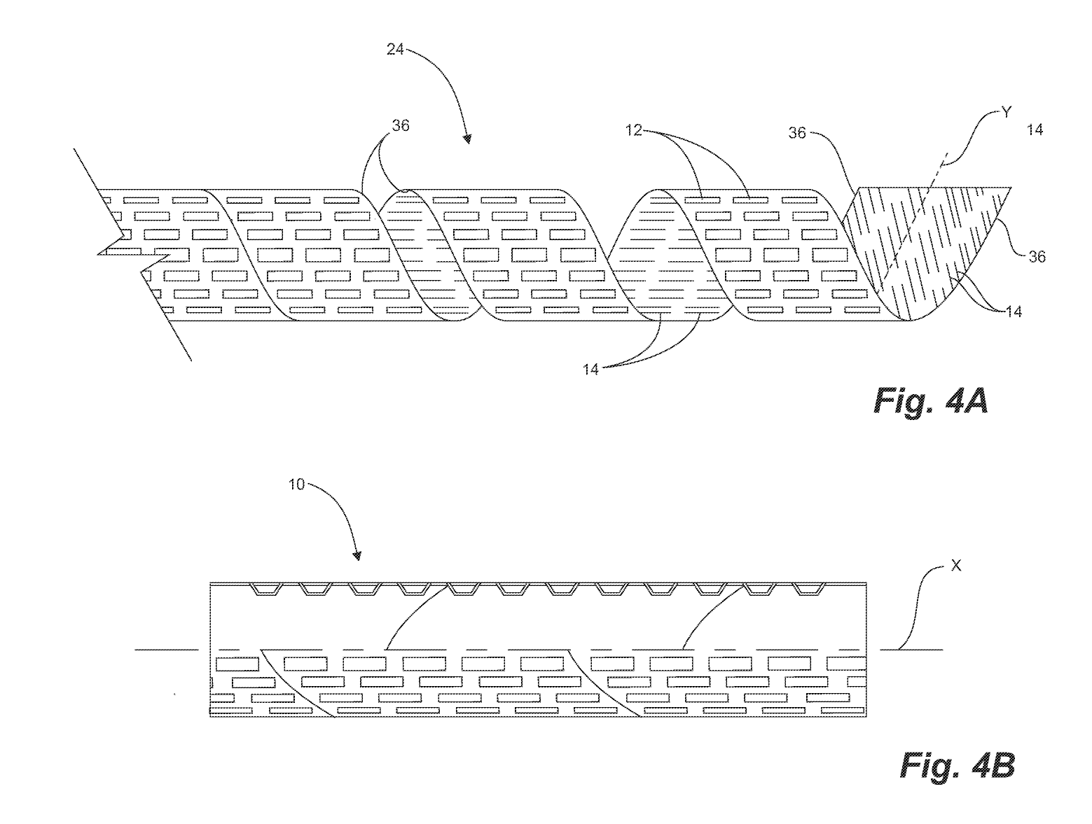

As shown in FIGS. 4A and 4B, in an embodiment the cylindrical screen 10 can be formed from the strip 24 of stainless steel which is spiraled about the longitudinal axis Y of the strip 24, the longitudinal edges 36 being welded in a spiral weld pass for increasing the strength of the screen 10 and sand exclusion therefrom.

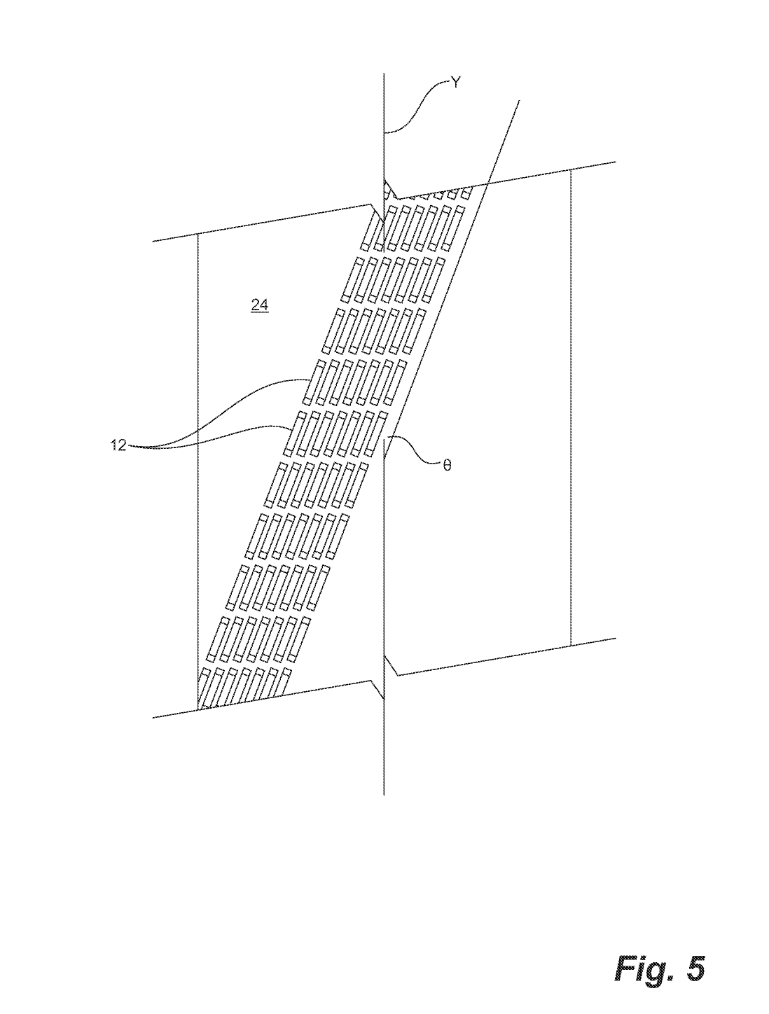

Having references to FIGS. 4A, 4B and 5, so as to result in a longitudinal arrangement once spiral welded, the slots 12 are punched in the flat strip 24 at a punching angle θ to the longitudinal axis Y of the strip 24. As the strip 24 is spiraled about the strip's longitudinal axis Y for forming the cylindrical screen 10, the slots 12 become longitudinally extending and generally parallel to the longitudinal axis X of the cylindrical screen 10 formed therefrom.

To further strengthen the cylindrical screen 10, the welds, typically made using argon-arc welding, are annealed at annealing temperatures as is understood by those of skill in the art.

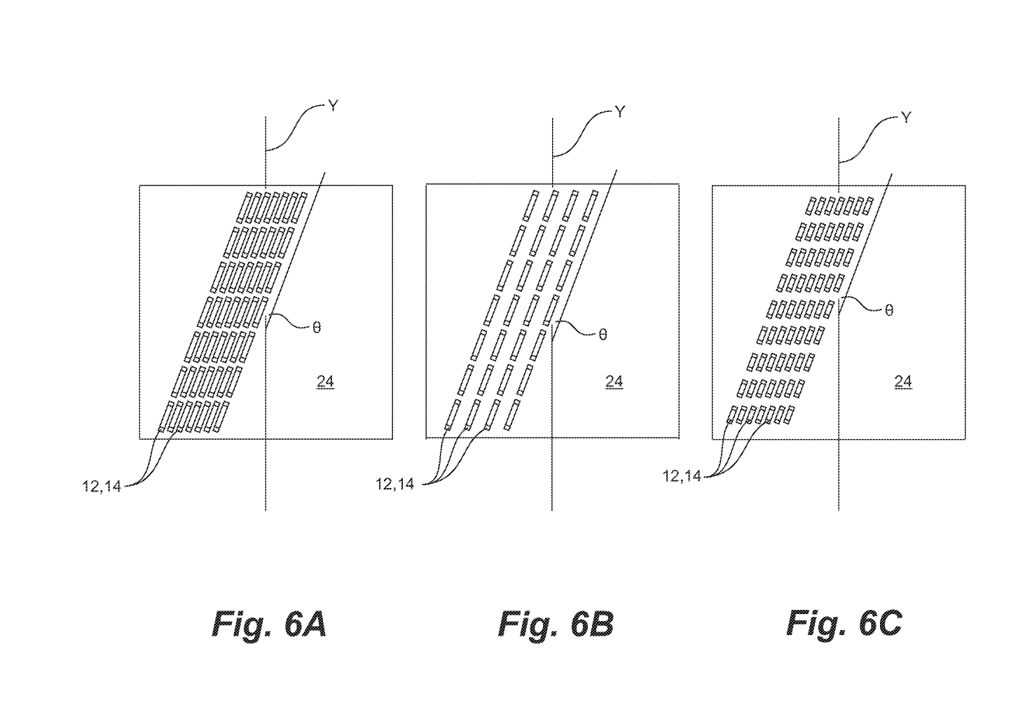

As shown in FIGS. 6A to 6C, a flow or open area of the screen 10, generally defined by the density and size of the apertures 14 punched in the screen material 24 can be customized for various applications, as is understood by those of skill in the art. In embodiments, the open area can be varied from about 2% to about 20%. Generally, a plurality of the slots 12 are punched in patterns, such as in circumferential spiral rows in the screen material 24 to result in axial offsetting of the slots 12, to achieve the desired open area.

Alternatively, in embodiments, the punching angle θ is adjusted so as to position the longitudinally extending slots 12 at an angle of between 0° and about 90° relative to the longitudinal axis X of the screen 10. More particularly the slots 12 are at less than about 45° relative to the longitudinal axis X. Even more particularly, the slots are from 0° to about 15° and are generally longitudinally aligned with the longitudinal axis X when spiral welded to form the cylindrical screen 10.

When the slots 12 are angled as described, the screen 10 has greater resistance to radial deflection and buckling, particularly when used for thermal recovery of hydrocarbons, such as in steam assisted gravity drainage (SAGD) operations. One of skill in the art however will recognize that although the screen 10 has greater collapse or buckling resistance when the slots 12 are angled from the longitudinal axis X, the greater the angle the less the tensile resistance and the greater the risk of damage during run-in.

As discussed above, where different materials are used to manufacture the casing 18, the cylindrical screen 10 and connections therebetween, expansion rates under thermal conditions such as SAGD, where temperatures may exceed 200° C., can result in different thermal expansion and contraction rates for each material. The difference may result in damage to connections between the components of the screen assembly 10 resulting in buckling and failure of the screen 10 with loss of sand control.

### Screen Punching

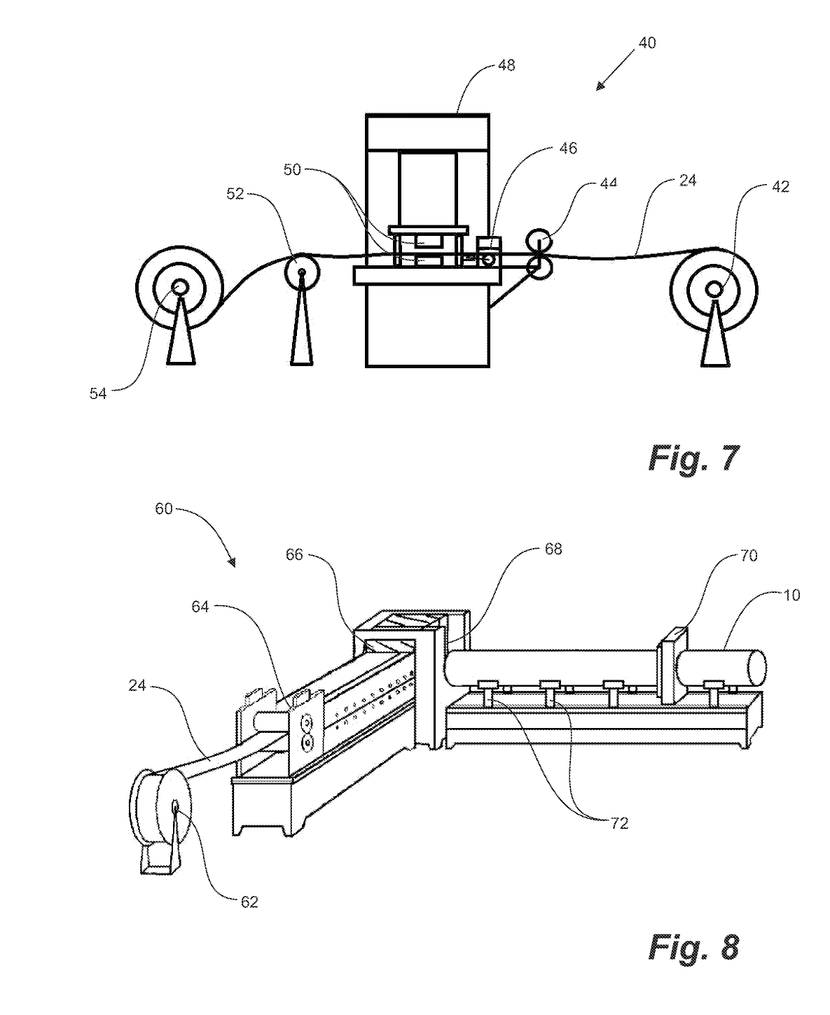

In an embodiment, as shown in FIG. 7, apparatus 40 for punching screen material 24 generally comprises an automatically rotatable feed device 42, a feed-limiting stopper 44, a speed and position control device 46, a punching press 48 having punch tooling 50, a support guide pulley 52, and a recycling and winding unit 54. An optional cooling unit and other components for handling the materials may be utilized.

A roll of screen material 24, such as stainless steel, having a desired width, is placed on the automatically rotatable feed device 42. A leading edge of the material 24 is passed through the apparatus 40 and is ultimately connected to the recycling and winding unit 54 which rolls the punched screen 10 when the punching operation is completed. The apparatus 40 is operated to feed and punch the material fed therethrough so as to ensure the plurality of slots 12 are distributed evenly throughout the material 24 as is understood in the art. The punch tooling 50 is adjusted accordingly to manufacture the number and size of slots 12, sizes of apertures 14 to result in the desired overall flow area. Further, the punch tooling 50 is adjustable to ensure the correct punching angle θ, such as to result in slots 12 which are parallel to the longitudinal axis X of the completed cylindrical screen 10. Further, the apparatus 40 is adjustable to accept different widths of material 24 so as to permit manufacture of cylindrical screens 10 of different diameters to fit concentrically over casing 18 having different diameters. To maintain precision in the size of the slots 12 and apertures 14, the punch tooling 50 is periodically trimmed or sharpened.

Having reference to FIG. 8, an embodiment of a forming and welding apparatus 60 to produce a spiral-welded cylindrical screen 10 comprises an automatically rotatable feed device 62, a feed-limiting stopper 64, a spiral roller forming device 66, a welder 68 and a cutting machine 70 having support brackets 72. Other material handling components may be incorporated as is understood by those of skill in the art.

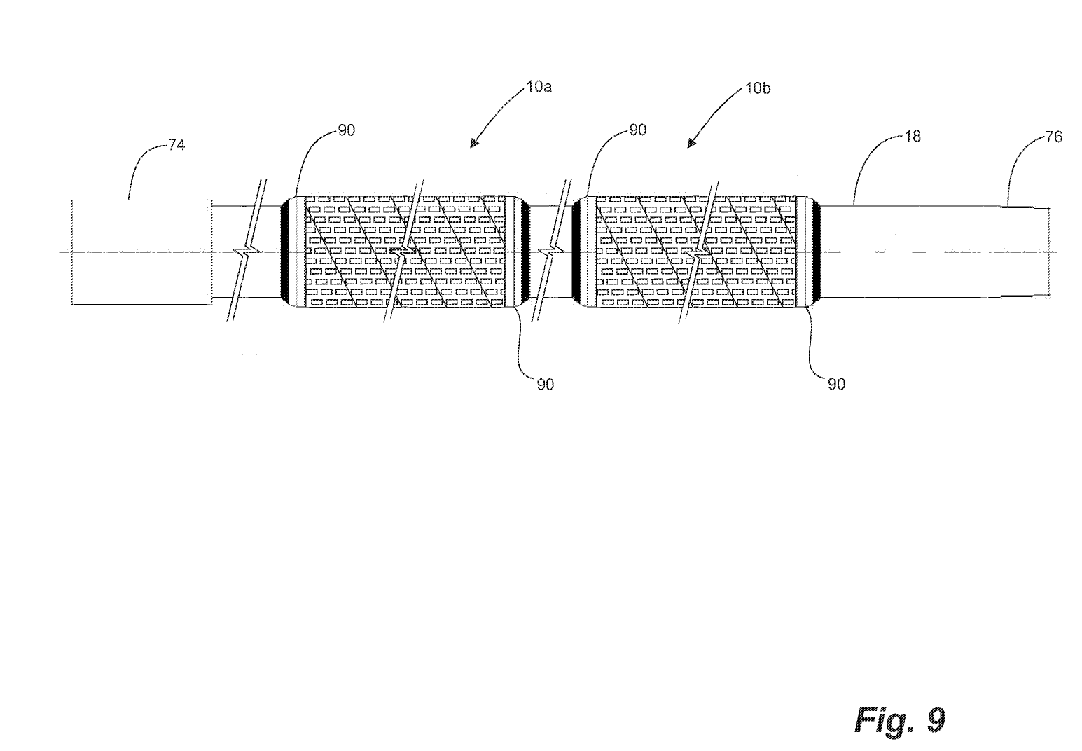

The punched and rolled screen material 24, which has been punched at a punching angle θ suitable for producing the spiral-welded cylindrical screen 10, is removed from the punching apparatus 40 and is supported in the automatically rotatable feed device 62. A leading edge of the punched material 24 is fed through the feed-limiting stopper 64 and is connected to the spiral roller forming device 66. Once connected, the forming and welding apparatus 60 is started. The rotatable feed device 62 feeds the material continuously through the spiral roller forming device 66 for spiraling the material 24. The spiral-formed material 24 is passed through the welder 68 for spiral-welding the longitudinal edges 36 of the material 24 into the cylindrical screen 10. Following the welding process, a continuous length of the cylindrical screen 10 is supported by the brackets 72 and cut into desired lengths using the cutting machine 70. In embodiments, the cutting machine 70 is an argon-arc welding cutter. As is understood by those of skill in the art, and having reference to FIG. 9, the desired lengths are typically sufficient to cover one or more portions of a length of casing 18 which have distributed holes formed therein while leaving unperforated portions of the casing 18, including connecting ends thereof, free of screen.

As is well understood by those of skill in the art, operating parameters for the forming and welding apparatus 50 can be adjusted to produce cylindrical screens having different diameters.

### Screen Assembly

Having reference to FIGS. 1, 9, 10A, 10B and 11, once manufactured, the cylindrical screens 10 are assembled with the casing 18 for use in oil and gas operations. The casing 18 is typically in accordance with API standards and having opposing box and pin ends 74,76. A plurality of distributed holes or perforations 80 are formed along at least a portion of the casing 18 to permit fluid inflow from the formation to a bore 82 of the casing 18. In embodiments, the distributed holes 80 can be in either spiral or parallel patterns. The cylindrical screen 10, manufactured according to embodiments taught herein, is fit concentrically about the casing 18. In embodiments, the cylindrical screen 10 is slid longitudinally onto the casing 18, the casing 18 fitting within a bore 44 of the cylindrical screen 10. The longitudinal axis X of the cylindrical screen 10 is generally coaxial and common with a longitudinal axis X′ of the casing 18.

In embodiments, to affix the cylindrical screen 10 concentrically about the casing 18, opposing end caps 90 are used. The end caps 90 engage between the screen 10 and the casing 18 for positioning the screen 10 relative to the distributed perforations 80 in the casing 18.

Each end cap 90 comprises a tubular body 92 and a bore 94. The bore 94 comprises a first portion 96 which has a first inner diameter to engage concentrically over the casing 18 for affixing the end cap 90 thereto. The bore 94 further comprises a second portion 98 extending outwardly from the first portion 96 which has a second, inner diameter for engaging concentrically over the casing 18 and the cylindrical screen 10.

In embodiments, each end cap 90 is slid concentrically over the casing 18, the casing 18 passing through the end cap's bore 94 until the second portion 98 of the cap's bore 94 is fit concentrically over an end 100 of the screen 10. A shoulder 102 in the cap's bore 94, formed between the first and second portions 96,98, limits the axial movement of the end cap 90 as the end 100 of the screen 10 engages the shoulder 102. The end cap 90 is secured to casing 18 at a first end 104, adjacent the bore's first portion 96. In embodiments, the end cap 90 is secured to the casing 18 using a continuous weld which excludes sand entry therebetween. Further, the end cap 90 is secured to the screen 10 at a second, opposing end 106 which overlaps the screen 10, such as with a continuous weld. Advantageously, the welds at the first and second ends 104,106 of the end cap 90 form chamfers which minimize catching edges so as to aid in movement of the casing 18 within the wellbore 20. Optionally, the end caps 90 can be formed having chamfers at the first end 104, the second end 106 or at both.

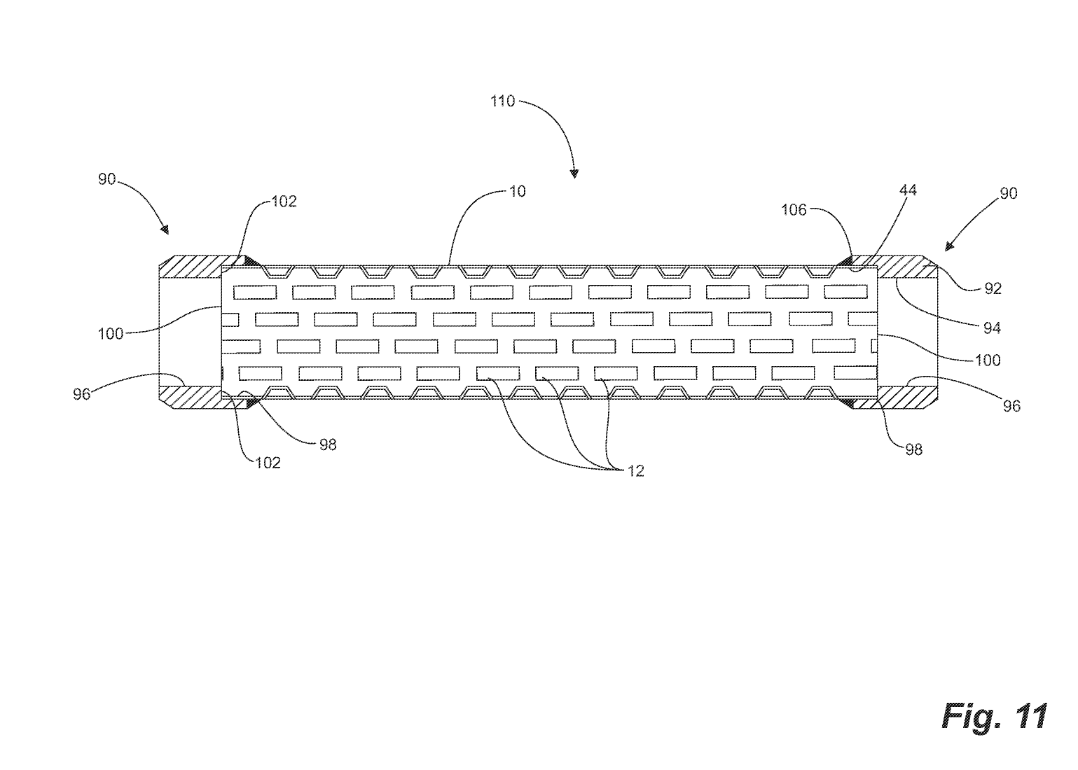

In an embodiment, having reference to FIG. 11, a screen assembly 110 is manufactured which comprises the cylindrical screen 10 to which end caps 90 have been pre-welded. Each end cap 90 is slid concentrically over the end 100 of the screen 10 until the end 100 engages the shoulder 102. The end cap 90 is then welded to the screen 10. The screen assembly 110 is then provided for assembly with the casing 18. The screen assembly 110 is slid concentrically over the casing 18 and when positioned, the first end 104 of the end cap 90 is affixed, such as by welding, to the casing 18.

In embodiments, additional layers of filtering material may be sandwiched between the cylindrical screen 10 and the casing 18.

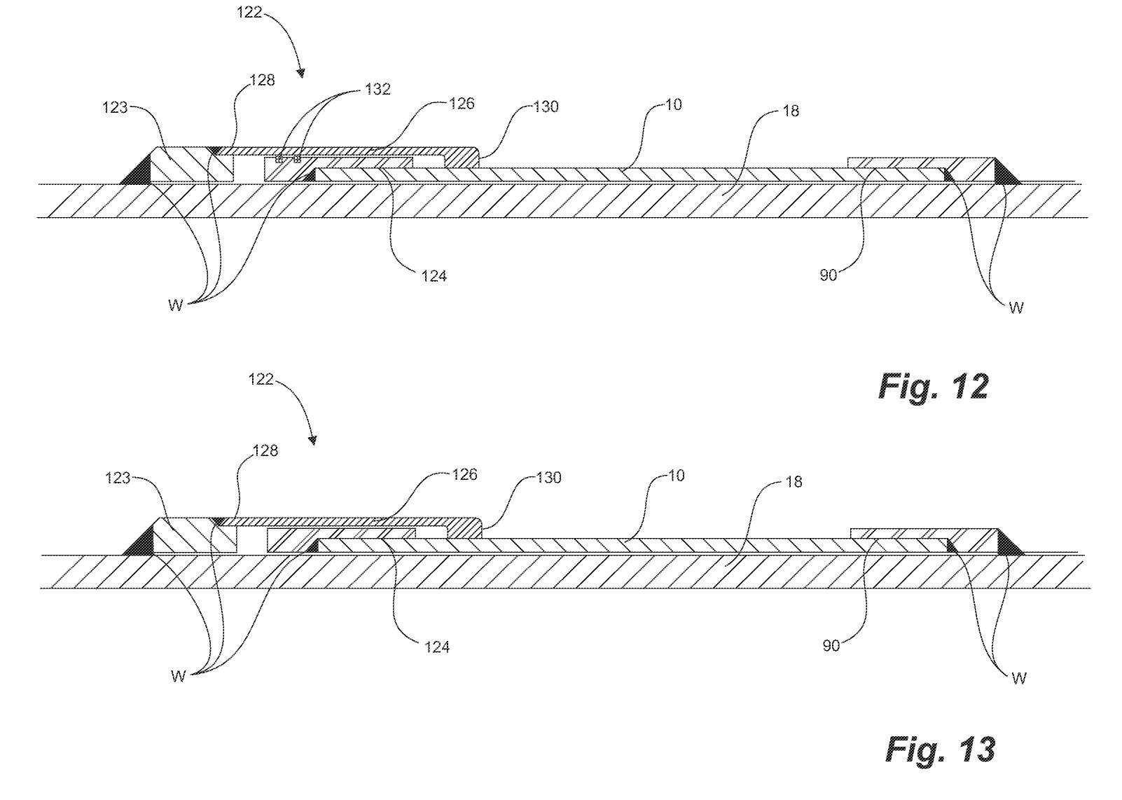

Having reference to FIGS. 12 to 15, in embodiments a screen assembly 120 further comprises an expansion joint 122 associated with at least one of the end caps 90 which permits relative thermal expansion and contraction between the casing 18, the cylindrical screen 10, the end caps 90 and connections therebetween without compromising the integrity of the screen assembly 120.

The cylindrical screen 10 is fixed, such as by welding W, at one end to an end cap 90 as described above. At the opposing end, the cylindrical screen 10 is fixed W to a sliding or moveable ring 124 which is spaced from a support ring 123 so as to provide longitudinal room for expansion therebetween. The support ring 123 replaces the fixed end cap 90 of earlier embodiments. The moveable ring 124 is fit concentrically over the casing 18 but is freely moveable thereon. A connecting ring 126 is fixed, such as by welding W, at a first end 128, to the support ring 123 and extends longitudinally and concentrically over the moveable ring 124. An inwardly depending second end 130 of the connecting ring 126 is spaced away from the moveable ring 124. The second end 130 depends radially inwardly to a diameter about that of the cylindrical screen 10 for minimizing sand entry therebetween while permitting the cylindrical screen 10 to move longitudinally therebeneath during differential expansion or contraction of the cylindrical screen 10 relative to the casing 18. The inwardly depending second end 130 also acts to limit the movement of the moveable ring 124 and screen 10 attached thereto.

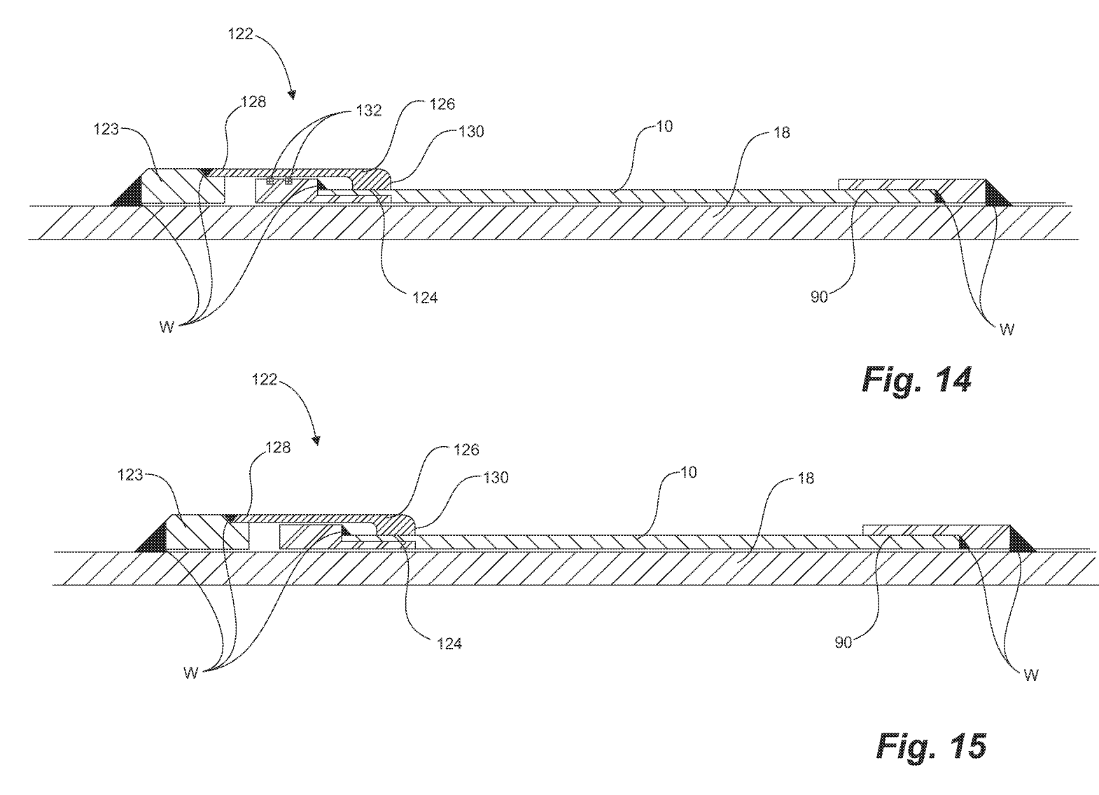

The embodiments of FIGS. 12 and 13 have one method of affixing moveable ring 124 to the screen 10 compared to the method of affixing set forth in FIGS. 14 and 15.

In the embodiments shown in FIGS. 12 and 14, seals 132 are positioned between the moveable ring 124 and the connecting ring 126 to minimize sand entry therebetween.

In the embodiments shown in FIGS. 13 and 15, metal-to-metal contact between the moveable ring 124 and the connecting ring 126 further minimizes the entry of sand.

Having reference again to FIGS. 12 and 13, in these embodiments, the moveable ring 124 extends over the cylindrical screen 10 and has an inner shoulder formed thereon to which the end of the cylindrical screen is welded.

Having reference again to FIGS. 14 and 15, in these embodiments, a portion of the moveable ring 124 extends beneath the end of the cylindrical screen 10 which is profiled to accommodate the moveable ring 124. The end of the cylindrical screen 10 overlays the portion of the moveable ring 124 which extends beneath and engages a shoulder 134 formed in the moveable ring 124. The cylindrical screen 10 is fixed, such as by welding at the shoulder 134. Similarly, the profiled end of the cylindrical screen 10 forms a shoulder 136 against which the moveable ring 124 engages.

### EXAMPLES

As an example, having reference to FIG. 9, two cylindrical spiral-welded screens 10 were manufactured according to FIGS. 4A and 4B, each having a length of about 16 ft.

A 45 ft length of 8⅝″ casing 18, having conventional, API standard, opposing box and pin ends 74,76, was perforated in two, spaced apart sections intermediate ends of the casing 18. The first cylindrical screen 10a with opposing end caps 90 was installed onto the casing 18 as described herein. The first screen 10a, installed over the first section of perforations, was spaced about 2-3 ft from the box end 74. The second screen 10b was spaced from the first screen 10a by about 10 ft.

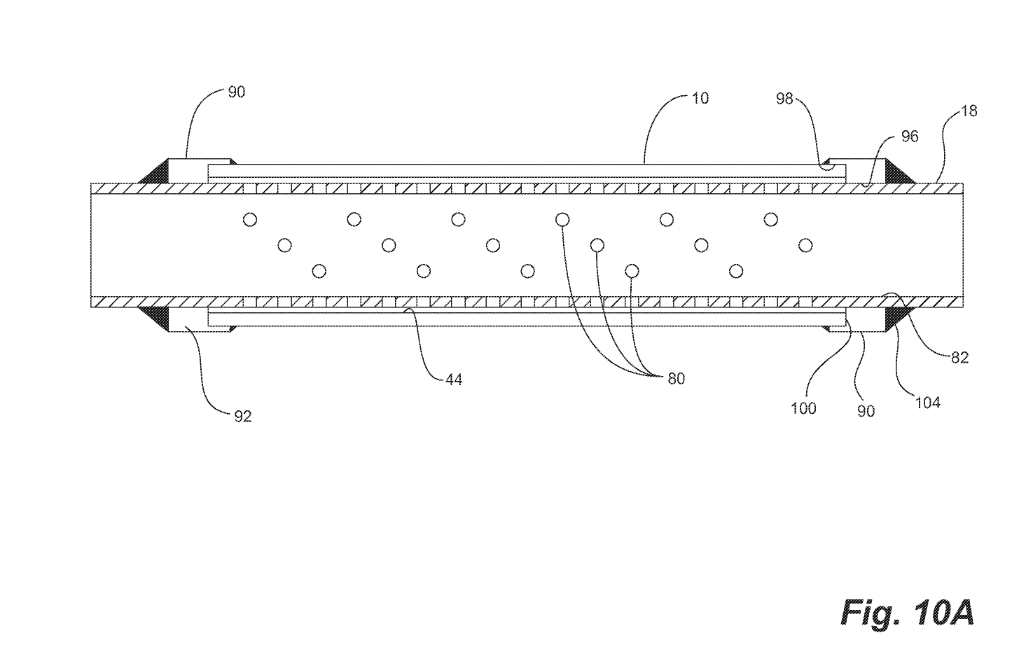

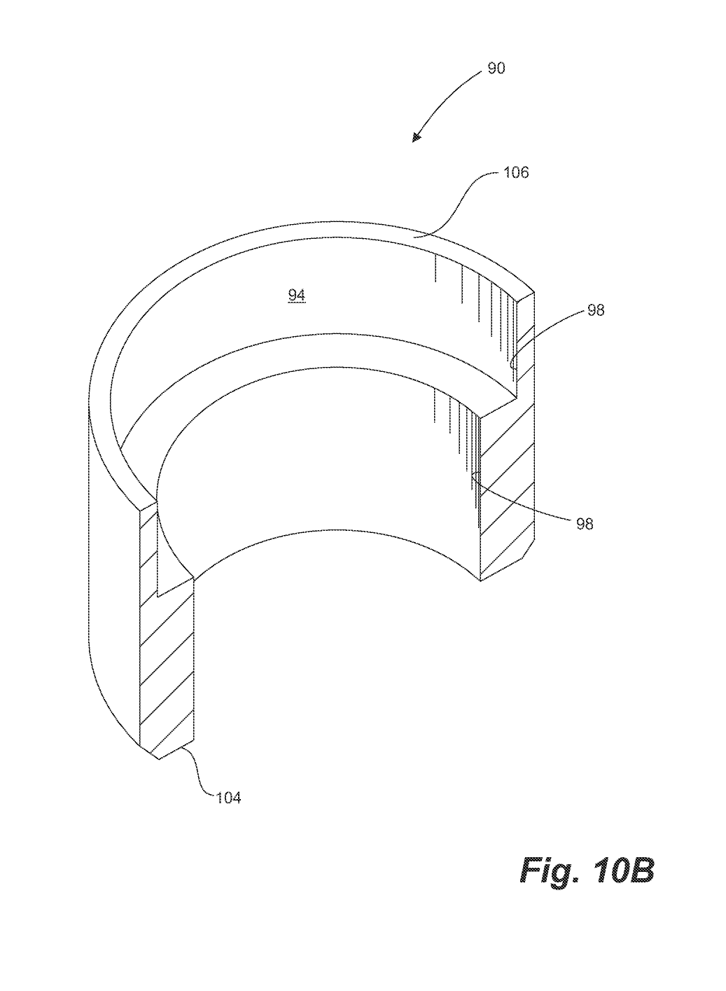

In another example, illustrated generally in FIG. 10A, a screen 10 according to embodiments taught herein, was manufactured to be used with conventional API casing 18 perforated with circular holes 80 about 13 mm in diameter at a density of about 430 holes per meter to provide an open area in the casing 18 of about 7%. The holes 80 were perforated in the casing 18 in a spiral pattern thereabout.

The screen 10 was punched in 304L stainless steel 24 having a thickness of about 1.5 mm. Apertures 14 formed as a result of punching the slots 12 were 10±1 mm in length and about 0.2 mm in width. The total number of apertures 14 formed per meter of material was about 8500.

The embodiments for which an exclusive property or privilege is claimed are defined as follows:

1. A screen assembly for use with a perforated casing having a longitudinal axis, for control of sand production therethrough in a wellbore, the screen assembly comprising:
a cylindrical screen having a bore for fitting concentrically about the casing, the screen formed from a strip of material having a longitudinal extent, rolled in a spiral and affixed in a spiral seam, the screen having a longitudinal axis common with the casing, an outer surface and an inner surface;
a plurality of slots punched in the material, each slot having leading and trailing ends and first and second sides aligned with the common axis, the punched material being deformed inwardly for forming each slot so as to space the outer surface within the slot a distance below the inner surface of the material thereabout forming an aperture along each of the first and second sides of the slot and a smooth transition at the leading and trailing ends, the apertures being fluidly connecting from outside the screen to the screen's bore while excluding at least a portion of sand from passing therethrough; and
first and second tubular end caps positioned at opposing ends of the screen for connecting between the screen and the casing and retaining the screen therealong.

2. The screen assembly of claim 1 wherein a bore of each of the first and second tubular end caps further comprises:
a first portion having a first inner diameter to engage concentrically over the casing for affixing the end cap thereto; and
a second portion extending from the first portion and having a second inner diameter for engaging concentrically over the screen.

3. The screen assembly of claim 1 wherein each of the end caps is affixed to the casing by spot welding.

4. The screen assembly of claim 1 wherein each of the end caps is affixed to the casing by continuous welding.

5. The screen assembly of claim 1 wherein the punched slots are rectangular, trapezoidal or semi-elliptical.

6. The screen assembly of claim 1 wherein a width of the aperture is from about 0.15 mm to about 0.3 mm.

7. The screen assembly of claim 1 comprising an open flow area of from about 2% to about 20%

8. The screen assembly of claim 1 further comprising:
a filter layer sandwiched between the screen and the casing.

9. The screen assembly of claim 8 wherein the filter layer is affixed to the casing, the screen fitting concentrically thereover.

10. The screen assembly of claim 8 wherein the filter layer comprises a woven wire mesh.

11. The screen assembly of claim 1 further comprising an expansion joint for permitting differential and longitudinal thermal expansion between the screen and the casing.

12. The screen assembly of claim 1 wherein the slots are angled from about 0° to about 90° relative to the common axis.

13. The screen assembly of claim 12 wherein the slots are angled less than about 45° relative to the common axis.

14. The screen assembly of claim 12 wherein the slots are angled from 0° to about 15° and are generally longitudinally extending.

15. A screen for use with a perforated casing having a longitudinal axis, for control of sand production therethrough, the screen comprising:
a cylindrical screen for fitting concentrically about the casing formed from a strip of material having a longitudinal extent, the strip rolled in a spiral and affixed along the longitudinal extent in a spiral seam, the screen having a longitudinal axis common therewith, an outer surface and an inner surface; and
a plurality of slots punched in the screen, each slot having leading and trailing ends and first and second sides aligned with the common axis, the punched material being deformed inwardly for forming each slot so as to space the outer surface within the slot a distance below the inner surface of the material thereabout forming an aperture along each of the first and second sides of the slot and a smooth transition at the leading and trailing ends, the apertures being fluidly connecting from outside the screen to the screen's bore while excluding at least a portion of sand from passing therethrough.

16. The screen of claim 15 wherein the punched slots are rectangular, trapezoidal or semi-elliptical.

17. The screen of claim 15 wherein a width of the aperture is from about 0.15 mm to about 0.3 mm.

18. The screen of claim 15 further comprising an open flow area of from about 2% to about 20%

19. The screen of claim 15 wherein the slots are angled from about 0° to about 90° relative to the common axis.

20. The screen of claim 19 wherein the slots are angled less than about 45° relative to the common axis.

21. The screen assembly of claim 19 wherein the slots are angled from 0° to about 15° and are generally longitudinally extending.

22. A screen assembly for use with a perforated casing having a longitudinal axis, for control of sand production therethrough, the screen assembly comprising:
a cylindrical screen for fitting concentrically about the casing, the screen having a longitudinal axis common therewith, an outer surface and an inner surface;
a plurality of slots punched in the screen, each slot having leading and trailing ends and first and second sides aligned with the common axis, the punched material being deformed inwardly for forming each slot so as to space the outer surface within the slot a distance below the inner surface of the material thereabout forming an aperture along each of the first and second sides of the slot and a smooth transition at the leading and trailing ends, the apertures being fluidly connecting from outside the screen to the screen's bore while excluding at least a portion of sand from passing therethrough; and
first and second tubular end caps positioned at opposing ends of the screen for connecting between the screen and the casing and retaining the screen thereabout, each end cap having a cap bore formed therethrough, the cap bore having
a first portion having a first inner diameter to engage concentrically over the casing for affixing the end cap thereto; and
a second portion extending from the first portion and having a second inner diameter for engaging concentrically over the casing and the screen.

23. The screen assembly of claim 22 the screen further comprising a longitudinally extending welded seam therealong.

24. The screen assembly of claim 22 the screen further comprising a spirally extending welded seam therealong.

25. The screen assembly of claim 22 further comprising an expansion joint for permitting relative thermal expansion between the cylindrical screen and the perforated casing.

26. The screen of claim 22 wherein the slots are angled from about 0° to about 90° relative to the common axis.

27. The screen of claim 26 wherein the are angled less than about 45° relative to the common axis.

28. The screen assembly of claim 26 wherein the slots are angled from 0° to about 15° and are generally longitudinally extending.

29. A method for manufacturing a cylindrical screen for use with a perforated casing having a longitudinal axis, for control of sand production therethrough in a wellbore, the method comprising:
determining a longitudinal axis of a strip of material used for forming the screen;
determining an angle relative to the longitudinal axis at which a plurality of slots are to be punched so that when the strip of material is rolled in a spiral for forming a cylinder, the plurality of slots are generally longitudinally aligned with the longitudinal axis;
punching the plurality of slots at the determined angle in the strip of material wherein each slot has a leading and a trailing end and first and second sides, the punched material being deformed inwardly for forming each slot so as to space the outer surface within the slot a distance below the inner surface of the material thereabout forming an aperture along each of the first and second sides of the slot and a smooth transition at the leading and trailing ends, the apertures being fluidly connecting from outside the screen to the screen's bore while excluding at least a portion of sand from passing therethrough;
spiral rolling the strip of material for forming the cylinder; and thereafter
welding a spiral seam at abutting longitudinal edges of the strip of material for forming the cylindrical screen.

30. A method for installation of a screen assembly, for use with perforated casing having a longitudinal axis, for control of sand production therethrough in a wellbore, the method comprising:
manufacturing the cylindrical screen of claim 15;
sliding an end cap over each opposing end of the screen, each end cap having
a first portion having a first inner diameter to engage concentrically over the casing for connection thereto; and
a second portion extending from the first portion and having a second inner diameter for engaging concentrically over the casing and the screen; and
welding each end cap to the screen at an end adjacent the second portion of the bore.
